(19) United States
(12) Patent Application Publication
(10) Pub. No.: US 2017/0147440 A1
(43) Pub. Date: May 25, 2017

(54) Chip Initialization System and Method for Initializing Chip by Using Reset Pin

(71) Applicants: Inventec (Pudong) Technology Corp., Shanghai (CN); Inventec Corporation, Taipei (TW)

(72) Inventors: Kun-Sheng Chang, Taipei (TW); Hsu-Feng Chen, Taipei (TW)

(21) Appl. No.: 15/086,078

(22) Filed: Mar. 31, 2016

(30) Foreign Application Priority Data
Nov. 23, 2015 (CN) 201510817256.6

(51) Int. Cl. G06F 11/14; G06F 1/28; G06F 1/30; G06F 9/44

(52) U.S. Cl. CPC G06F 11/1438; G06F 9/4403; G06F 9/4406; G06F 1/28; G06F 1/30; G06F 2201/805

(57) ABSTRACT

A method for initializing a chip includes turning on a direct current power supply of the chip and transmitting an acknowledge signal after turning on the direct current power supply of the chip. Whether the acknowledge signal is received by a control device during a predetermined time interval is determined. If the acknowledge signal is not received by the control device, the acknowledge signal is regarded as an abnormal signal. If the acknowledge signal is abnormal, turn off the direct current power supply of the chip. After turning off the direct current power supply, change a voltage of a reset pin of the chip. After changing the voltage of the reset pin of the chip, turn on the direct current power supply of the chip again.

### BACKGROUND OF THE INVENTION

1. Field of the Invention

The present invention illustrates a chip initialization system and a method for initializing a chip, and more particularly, the chip can be initialized automatically by using a control device through a reset pin.

2. Description of the Prior Art

With the advancement of network techniques, various servers, computer terminals, personal computers, and communication stations are adopted for data transmission. Early computers or servers used mechanical typed devices or vacuum tubes with large volume for data processing, thereby leading to inconvenience and low performance. However, recent computers or servers use integrated circuits or micro-chips for processing data with extremely high computational performance and operation capability. Specifically, for a general Intel® chip set, although the chip set can provide excellent performance of floating point calculation, some unexpected errors or system failures may be occurred when the chip set is enabled.

In an official announcement by Intel®, no feasible method is made for solving unexpected errors or system failures. Thus, when the chip set is enabled and the unexpected errors or system failures are occurred, two empirical methods are introduced for initializing the chip set manually. In the first method, when the unexpected errors occurred from the chip are observed by a user, the user can use a jumper to trigger a reset pin (i.e., a pin of RTCRST_N) of the chip manually for initializing the chip. After the chip is initialized, the chip is reset and further inspected by the user. In the second method, when the unexpected errors occurred from the chip are observed by the user, the user disables or inverts a battery of the chip for discharging the chip of the chip set. After disabling the battery over a time period, the user enables the battery again. Specifically, an alternating current (AC) source has to be disabled (i.e., for example, pull out a plug from an electrical socket) before using these two aforementioned methods for initializing the chip. After the chip is reset by using the initialization methods manually, the AC source is enabled again (i.e., for example, push the plug into the electrical socket). By doing so, a computer or a server with the chip set has a chance to restart successfully.

However, the aforementioned methods for initializing the chip are inconvenient. For a manufacturing terminal, since the chip initialization process has to be operated manually, it requires numerous human resources when the chips are manufactured by a way of mass production. For a client terminal, the AC source has to be disabled first. After the AC source is disabled, the user has to unpack a shell of the computer or the server. Then, the reset pin is triggered by the user. Finally, the AC source has to be enabled again. Generally, no jumper (device) is reserved or disposed inside the chip set for initialing the chip. Thus, it is important to develop an automatic chip initialization method.

### SUMMARY OF THE INVENTION

In an embodiment of the present invention, a method for initializing a chip is disclosed. The method includes turning on a direct current power supply of the chip, transmitting a first acknowledgement signal after turning on the direct current power supply of the chip, determining whether the first acknowledgement signal is received by a control device during a predetermined time interval, when the first acknowledgement signal is not received by the control device during the predetermined time interval, turning off the direct current power supply of the chip, changing a voltage of a reset pin of the chip after turning off the direct current power supply, turning on the direct current power supply of the chip again after changing the voltage of the reset pin of the chip, transmitting a second acknowledgement signal after turning on the direct current power supply of the chip again, and when the second acknowledgement signal is not received by the control device, disabling the chip.

Another embodiment of the present invention discloses a chip initialization system. The chip initialization system includes a chip, a power device, and a control device. The chip includes a signal report pin for outputting an acknowledgement signal, and a reset pin for initializing the chip. The power device is coupled to the reset pin of the chip for providing a voltage of the reset pin. The control device is coupled to the signal report pin and the reset pin of the chip for controlling the chip. The control device turns on a direct current power supply of the chip and starts to receive a first acknowledgement signal after turning on the direct current power supply of the chip, when the first acknowledgement signal is not received by the control device, the control device turns off the direct current power supply of the chip, the control device changes a voltage of a reset pin of the chip after turning off the direct current power supply, the control device turns on the direct current power supply of the chip again after changing the voltage of the reset pin of the chip, the chip transmits a second acknowledgement signal after turning on the direct current power supply of the chip again, and when the second acknowledgement signal is not received by the control device, the chip is disabled by the control device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a block diagram of a chip initialization system according to an embodiment of the present invention.

FIG. 2 illustrates a flow chart of a method for initializing a chip of the chip initialization system in FIG. 1.

### DETAILED DESCRIPTION

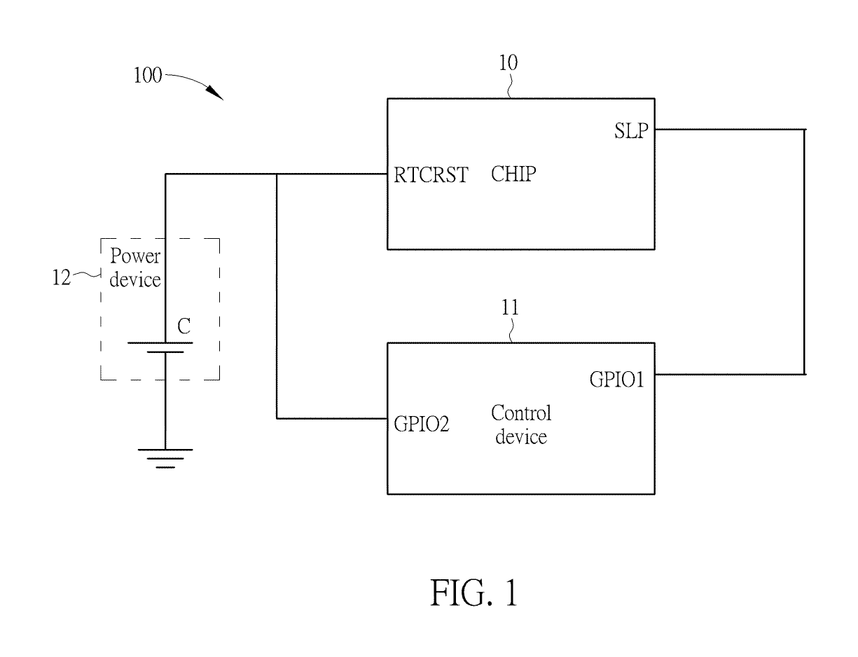

FIG. 1 illustrates a block diagram of a chip initialization system 100 according to an embodiment of the present invention. As shown in FIG. 1, the chip initialization system 100 includes a chip 10, a power device 12, and a control device 11. In the chip initialization system 100, the chip 10 can be a chip of a Southbridge chip set developed by Intel®. However, the chip 10 of the present invention is not limited to the chip of the Southbridge chip set. The control device 11 can be any programmable electronic device. For example, in the embodiment, the control device 11 can be a complex programmable logic device (CPLD). The power device 12 can be any power storage device, such as a battery or a capacitor. In the embodiment, the power device 12 includes a capacitor C. In the chip initialization system 100, the chip 10 includes a signal report pin SLP and a reset pin RTCRST. Specifically, the signal report pin SLP is used for outputting an acknowledgement signal (i.e., for example, a first acknowledgement signal or a second acknowledgement signal illustrated later). The reset pin RTCRST is used for initializing the chip 10. As known, when the chip 10 is considered as the chip of the Southbridge chip set developed by Intel®, an identifier of the reset pin RTCRST of the chip of the Southbridge chip set is RTCRST_N. An identifier of the signal report pin SLP of the chip of the Southbridge chip set is SLP_A_N. The power device 12 is coupled to the reset pin RTCRST of the chip 10 for providing a voltage of the reset pin RTCRST. In the embodiment, the capacitor C of the power device 12 includes a positive terminal and a negative terminal. The negative terminal is coupled to a grounded terminal. The positive terminal is coupled to the reset pin RTCRST of the chip 10. The control device 11 is coupled to the signal report pin SLP and the reset pin RTCRST of the chip 10 for controlling the chip 10. In other words, the control device 11 includes a first terminal GPIO1 and a second terminal GPIO2. The first terminal GPIO1 is coupled to the signal report pin SLP of the chip 10 for determining whether the control device 11 receives a valid acknowledgement signal transmitted from the chip 10. The acknowledgement signal is considered as the first acknowledgement signal or the second acknowledgement signal. The second terminal GPIO2 is coupled to the reset pin RTCRST of the chip 10 for changing the voltage of the reset pin RTCRST according to a detection result of the acknowledgement signal.

In the embodiment, when the control device 11 is the complex programmable logic device (CPLD), the first terminal GPIO1 and the second terminal GPIO2 belong to two pins of the general purpose input/output (GPIO). Here, the control device 11 can detect whether the valid acknowledgement signal is transmitted from the chip 10. Then, the control device 11 can determine whether the initialization process of the chip 10 is required according to a detection result.

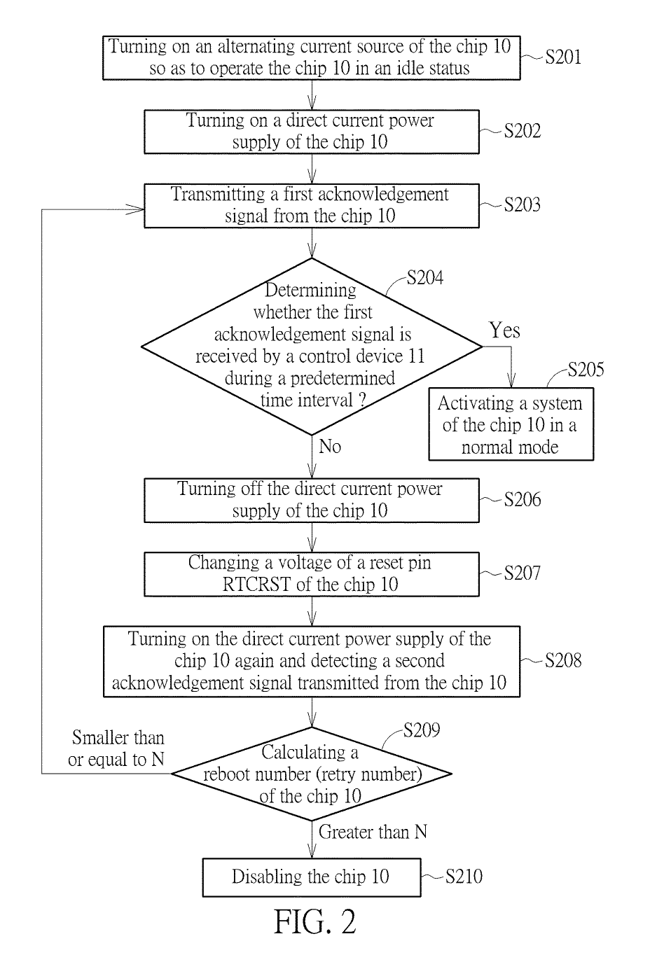

For presentation completeness, a flow chart of the initialization process is introduced in the following. A method for controlling and initializing the chip 10 by the control device 11 is illustrated below. FIG. 2 illustrates a flow chart of a method for initializing a chip of the chip initialization system 100. The method for initializing a chip of the present invention can also be applied to other chip initialization systems. In FIG. 2, the method for initializing the chip 10 includes Step S201 to Step S210, as illustrated below.

Step S201: turning on an alternating current source of the chip 10 so as to operate the chip 10 in an idle status;

Step S202: turning on a direct current power supply of the chip 10;

Step S203: transmitting a first acknowledgement signal from the chip 10;

Step S204: determining whether the first acknowledgement signal is received by a control device 11 during a predetermined time interval; if yes, go to Step S205; if no, go to Step S206;

Step S205: activating a system of the chip 10 in a normal mode;

Step S206: turning off the direct current power supply of the chip 10;

Step S207: changing a voltage of a reset pin RTCRST of the chip 10;

Step S208: turning on the direct current power supply of the chip 10 again and detecting a second acknowledgement signal transmitted from the chip 10;

Step S209: calculating a reboot number (retry number) of the chip 10, when the reboot number of the chip 10 is greater than N, go to Step S210, when the reboot number of the chip 10 is smaller than or equal to N, go back to Step S203;

Step S210: disabling the chip 10.

For presentation convenience, the chip initialization system 100 is considered for applying to a computer or a server. In Step S201, a user turns on the alternating current (AC) source of the chip 10 (for example, pushes a plug into the electrical socket). Then, the chip 10 is operated in the idle status. In Step S202, a power key of the computer or the server can be triggered (or say, pressed) manually or automatically for turning on the direct current (DC) power supply of the chip 10.

After turning on the direct current power supply of the chip 10, the chip 10 transmits the first acknowledgement signal from a signal report pin SLP in Step S203. Specifically, the first acknowledgement signal in Step S203 is defined as a broadly-defined acknowledgement signal. For example, the first acknowledgement signal in Step S203 can be a complete acknowledgement signal when the chip 10 is operated in a normal status. The first acknowledgement signal in Step S203 can be a fragmented acknowledgement signal, a distorted acknowledgement signal, a null acknowledgement signal, or a void acknowledgement signal when the chip 10 is operated in an error or an abnormal status.

In the following, in Step S204, the control device 11 uses the first terminal GPIO1 (i.e., a pin of general purpose input/output) to detect whether a normal first acknowledgement signal is received by the control device 11. The control device 11 further determines whether the initialization of the chip 10 is required according to a detection result. In practice, the control device 11 uses a watchdog mechanism to detect whether the normal first acknowledgement signal is received by the first terminal GPIO1 during the predetermined time interval (i.e., for example, seven seconds time duration). If the normal first acknowledgement signal is received by the control device during the predetermined time interval, it implies that no unexpected error is occurred from the chip 10. Thus, a system of the computer or the server can be activated in the normal mode in Step S205. Conversely, if the first acknowledgement signal is not received by the control device 11 during the predetermined time interval, the first acknowledgement signal is abnormal. It implies that some unexpected errors are occurred from the chip 10. Then, the chip initialization system 100 goes to Step S206.

Specifically, in the embodiment, a decision algorithm for determining an operation status of the chip 10 is to detect whether the first acknowledgement signal is received by the control device 11. However, the decision algorithm of the present invention is not limited thereto. In other embodiments, the control device 11 can use various decision algorithms for determining the operation status of the chip 10. For example, a decision algorithm for determining the operation status of the chip 10 can use signal integrity of the first acknowledgement signal or information content of the first acknowledgement signal. When the control device 11 determines that the first acknowledgement signal is abnormal, the chip initialization system 100 goes to Step S206.

In Step S206, the control device 11 turns off the direct current power supply of the chip 10. Particularly, the Step S206 is regarded as a pre-process step for initializing the chip 10. In the following, in Step S207, The control device 11 changes the voltage of the reset pin RTCRST of the chip 10 through a second terminal GPIO2 . For example, The control device 11 decreases the voltage of the reset pin RTCRST of the chip 10 to reach a low voltage through a second terminal GPIO2 over a reset time interval (i.e., for example, one or two seconds). Specifically, a length of the reset time interval is required to be enough for triggering an initialization operation of the chip 10. Then, in Step S208, the control device 11 turns on the direct current power supply of the chip 10 again. Particularly, the Step S206, the Step S207, and the Step S208 can be formed as an operation loop and can be processed repetitively until the control device 11 receives a normal (valid) acknowledgement signal transmitted from the chip 10. However, to avoid infinite operation of the loop, the chip initialization system 100 can introduce a process for calculating a retry (reboot) number of the chip 10. For example, after the chip initialization system 100 turns on the direct current power supply of the chip 10 again in Step S208, the chip 10 may transmit a second acknowledgement signal. In the following, the control device 11 calculates the reboot number of the chip 10 in the Step S209. Specifically, in the embodiment, although the chip initialization system 100 can use the control device 11 to calculate the reboot number of the chip 10, the present invention is not limited thereto. For example, any device with calculation capability or programmable capability can be applied to calculate the reboot number of the chip 10. In Step S209, when the reboot number of the chip 10 is greater than N, the chip initialization system 100 goes to Step S210 and then disables the chip 10 since the chip 10 may be in breakdown and thus fails to initialize. In Step S210, the control device 11 also transmits a chip error message to the user and then locks an operating system of the chip 10 for avoiding data loss. Conversely, when the reboot number of the chip 10 is smaller than or equal to N, the chip initialization system 100 goes back to Step S203 and continuously detects whether a normal second acknowledgement signal is received by the control device 11. Then, the control device 11 determines whether the initialization of the chip 10 is required again according to the detection result.

In the embodiment, the process for calculating the retry (reboot) number of the chip 10 can be any calculating process. For example, a flag can be introduced to the chip initialization system 100. A value of the flag can be equal to zero initially. In Step S206, when the chip initialization system 100 turns off the direct current power supply of the chip 10, the value of the flag is increased to one. In other words, consider the operation loop processed repetitively. When the Step S206 of the operation loop is processed, the value of the flag is increased to one. Thus, the value of the flag is monotonically increased. The control device 11 can acquire the reboot number of the chip 10 by observing the value of the flag (i.e., the value of the flag is equal to the reboot number of the chip 10) . Further, in the embodiment, N is a user-defined positive integer. For example, N can be a positive integer between three and five. Additionally, the decision algorithm for determining the operational status of the chip 10 can be performed by detecting whether the normal first or second acknowledgement signal is received by the control device 11 during the predetermined time interval according to a power sequence or a power schedule. By processing the Step S201 to the Step S210, the chip 10 can be automatically initialized by the control device 11 when the reboot number of the chip 10 is tolerable. As a result, the chip initialization method of the present invention can be operated automatically, leading to improve operation convenience.

To sum up, the present invention discloses a chip initialization system and a method for initializing a chip. The idea is to use a control device for detecting whether an (normal) acknowledgement signal is received by the control device after turning on a direct current power supply of the chip. When the acknowledgement signal is abnormal or no acknowledgement signal is received by the control device, the control device decreases a voltage of a reset pin of the chip automatically for initializing the chip. Thus, additional processes of enabling/disabling an alternating current source manually are not required for initializing the chip. Further, it is unnecessary to unpack a shell of a computer or a server for triggering the reset pin by a jumper manually. In the present invention, since a chip error detection process and a chip initialization process can be performed automatically, the user can activate an operating system of the chip smoothly. Thus, the method for initializing the chip of the present invention provides high operation convenience. Additionally, when the user turns on the direct current power supply (i.e., presses a power key) of the computer or the server, the operating system of the computer or the server has high probability to avoid system crash by using the chip initialization system of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for initializing a chip, comprising:
turning on a direct current power supply of the chip;
transmitting a first acknowledgement signal after turning on the direct current power supply of the chip;
determining whether the first acknowledgement signal is received by a control device during a predetermined time interval;
when the first acknowledgement signal is not received by the control device during the predetermined time interval, turning off the direct current power supply of the chip;
changing a voltage of a reset pin of the chip after turning off the direct current power supply;
turning on the direct current power supply of the chip again after changing the voltage of the reset pin of the chip;
transmitting a second acknowledgement signal after turning on the direct current power supply of the chip again; and
when the second acknowledgement signal is not received by the control device, disabling the chip.

2. The method of claim 1, wherein the control device is a complex programmable logic device.

3. The method of claim 1, wherein changing the voltage of the reset pin of the chip is decreasing the voltage of the reset pin to reach a low voltage over a reset time interval.

4. The method of claim 1, further comprising:
calculating a reboot number of the chip; and
when the reboot number of the chip is greater than N, transmitting a chip error message from the control device and locking an operating system of the chip by the control device;
wherein N is a predetermined positive integer.

5. The method of claim 1, wherein the chip is a Southbridge chip developed by Intel®, and the reset pin is an RTCRST_N pin of the Southbridge chip developed by Intel®.

6. A chip initialization system, comprising:
a chip, comprising:
a signal report pin configured to output an acknowledgement signal; and
a reset pin configured to initialize the chip;
a power device coupled to the reset pin of the chip and configured to provide a voltage of the reset pin; and
a control device coupled to the signal report pin and the reset pin of the chip and configured to control the chip;
wherein the control device turns on a direct current power supply of the chip and starts to receive a first acknowledgement signal after turning on the direct current power supply of the chip, when the first acknowledgement signal is not received by the control device, the control device turns off the direct current power supply of the chip, the control device changes a voltage of a reset pin of the chip after turning off the direct current power supply, the control device turns on the direct current power supply of the chip again after changing the voltage of the reset pin of the chip, the chip transmits a second acknowledgement signal after turning on the direct current power supply of the chip again, and when the second acknowledgement signal is not received by the control device, the chip is disabled by the control device.

7. The system of claim 6, wherein the control device is a complex programmable logic device.

8. The system of claim 6, wherein the chip is a Southbridge chip developed by Intel®, and the reset pin is a RTCRST_N pin of the Southbridge chip developed by Intel®.

9. The system of claim 6, wherein the control device is operated to decrease the voltage of the reset pin of the chip over a reset time interval.

10. The system of claim 6, wherein the control device is operated to calculate a reboot number of the chip, when the reboot number of the chip is greater than N, transmitting a chip error message from the control device and locking an operating system of the chip by the control device, and N is a predetermined positive integer.
